(19) United States
(12) Patent Application Publication
(10) Pub. No.: US 2008/0051137 A1
(43) Pub. Date: Feb. 28, 2008

(54) VoIP apparatus embedded in mobile communication equipment

(75) Inventors: Chun Chieh Lee, Taipei (TW); Teng-Fu Hsu, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 11/892,505

(22) Filed: Aug. 23, 2007

(30) Foreign Application Priority Data
Aug. 23, 2006 (TW) 095130929

(51) Int. Cl. H04M 1/00

(52) U.S. Cl. 455/556.1

(57) ABSTRACT

The invention is to provide a VoIP apparatus embedded in a mobile communication equipment. The VoIP apparatus according to the invention includes a converting module. In particular, the converting module is used for converting voltage levels and interfaces between the communication module in the mobile communication equipment and the VoIP apparatus.

### BACKGROUND OF THE INVENTION

1. Field of the Invention

The invention relates to a VoIP apparatus embedded in a mobile communication equipment. In particular, the VoIP apparatus according to the invention has a converting module to convert a voltage level and an interface between a communication module in the mobile communication equipment and the VoIP apparatus.

2. Description of the Prior Art

A dual mode mobile phone combined with conventional mobile networks, for example, GSM, 3G, and WLAN technologies, is one of the popular communication technologies in recent years.

When a user is at home or works at home, the dual mode mobile phone can use a network phone service through automatically connecting a Wi-Fi network. When the user goes out or in a car, the dual mode mobile phone automatically turns to a mobile network to build a dead-spot free network environment. The dual mode mobile phone can form a seamless broadband application environment and save the communication expenses.

However, the specifications of mobile platforms on the market are different. For example, the data transmission interface of the mobile platform includes a universal asynchronous receiver transmitter (UART), universal serial bus, parallel bus, and memory bus, etc. It is not easy to add a function of VoIP into the mobile platform and also meet the requirement of entering the market immediately. Moreover, there is a problem of different voltage between the mobile platform and the VoIP module which is desired to be added.

Therefore, the scope of the invention is to provide a VoIP apparatus. The VoIP apparatus has a converting module. The converting module is capable of converting voltage levels of a signal and different interfaces of a mobile platform and the VoIP apparatus to let the dual mode mobile phone meet the goal of entering the market immediately.

### SUMMARY OF THE INVENTION

A scope of the invention is to provide a VoIP apparatus embedded in a mobile communication equipment. The VoIP apparatus has a converting module. The converting module is capable of converting the voltage levels of a signal and different interfaces of a mobile platform and the VoIP apparatus.

A first preferred embodiment according to the invention is a VoIP apparatus embedded in a mobile communication equipment. The mobile communication equipment comprises a communication processor having a first interface. The VoIP apparatus comprises a converting module, an encoding/decoding module, an antenna, and a wireless local communication module. The converting module connects with the first interface of the communication processor and has a second interface. An audio signal and/or a video signal with a first voltage level are transmitted between the communication processor and the converting module through the first interface. The encoding/decoding module connects with the second interface of the converting module. The encoding/decoding module is used for encoding or decoding the audio signal and/or the video signal in a VoIP protocol. The audio signal and/or the video signal with a second voltage level are transmitted between the converting module and the encoding/decoding module through the second interface. The converting module is operated by the communication processor and converts the voltage level of the audio signal and/or the video signal between the first voltage level and the second voltage level. The wireless local communication module is electrically connected to the encoding/decoding module and the antenna respectively. The wireless local communication module is used for transmitting the encoded audio signal and/or the encoded video signal out in a wireless local communication protocol via the antenna and receiving the encoded audio signal and/or the encoded video signal received by the antenna.

A second preferred embodiment according to the invention is a VoIP apparatus embedded in a mobile communication equipment. The mobile communication equipment comprises a communication processor. The communication processor has a first interface and encodes or decodes an audio signal and/or a video signal in a VoIP protocol. The VoIP apparatus comprises a converting module, an antenna, and a wireless local communication module. The converting module connects with the first interface of the communication processor and has a second interface. An audio signal and/or a video signal with a first voltage level are transmitted between the communication processor and the converting module through the first interface. The wireless local communication module is electrically connected to the converting module and the antenna respectively. The wireless local communication module is used for transmitting the encoded audio signal and/or the encoded video signal out in a wireless local communication protocol via the antenna and receiving the encoded audio signal and/or the encoded video signal received by the antenna. The audio signal and/or the video signal with a second voltage level are transmitted between the converting module and the wireless local communication module through the second interface. The converting module is operated by the communication processor and converts the voltage level of the audio signal and/or the video signal between the first voltage level and the second voltage level.

The advantage and spirit of the invention may be understood by the following recitations together with the appended drawings.

### BRIEF DESCRIPTION OF THE APPENDED DRAWINGS

FIG. 1 is a functional block diagram of the VoIP apparatus embedded in a mobile communication equipment in the first preferred embodiment according to the invention.

FIG. 2 is a functional block diagram of the VoIP apparatus embedded in a mobile communication equipment in another preferred embodiment according to the invention. The VoIP apparatus further comprises a clock generator for generating a clock.

FIG. 3 is a functional block diagram of the VoIP apparatus embedded in a mobile communication equipment in the second preferred embodiment according to the invention.

### DETAILED DESCRIPTION OF THE INVENTION

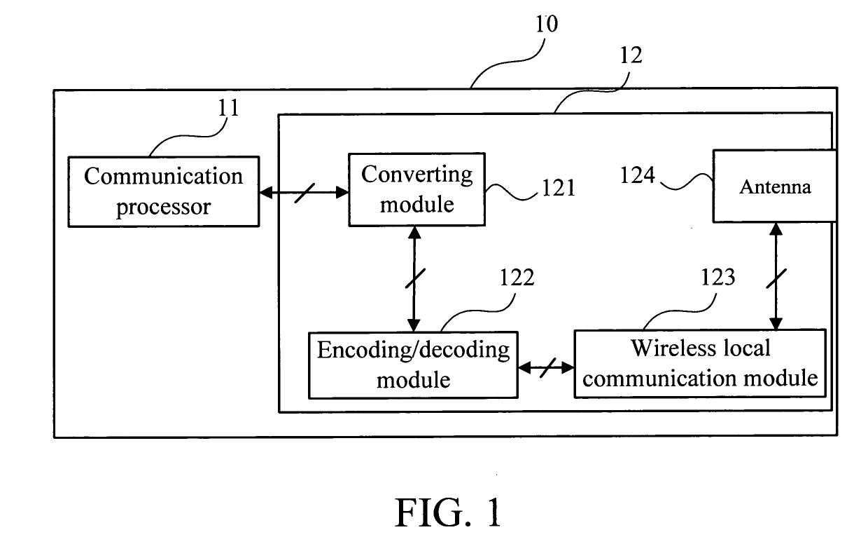

Please refer to FIG. 1. FIG. 1 is a functional block diagram of the VoIP apparatus embedded in a mobile communication equipment in the first preferred embodiment according to the invention.

As shown in FIG. 1, the VoIP apparatus 12 of the first preferred embodiment according to the invention is embedded in a mobile communication equipment 10. The mobile communication equipment 10 comprises a communication processor 11 having a first interface.

The VoIP apparatus 12 comprises a converting module 121, an encoding/decoding module 122, an antenna 124, and a wireless local communication module 123.

The converting module 121 connects with the first interface of the communication processor 11 and has a second interface. An audio signal and/or a video signal with a first voltage level are transmitted between the communication processor 11 and the converting module 121 through the first interface.

In an embodiment, the converting module 121 is a programmable logic device. For example, the programmable logic device can be a field programmable gate array (FPGA) or a complex programmable logic device (CPLD).

In an embodiment, the first interface is a UART interface and the second interface is a general purpose I/O (GPIO) interface.

In an embodiment, the first interface is a USB interface, and the second interface is a UART interface.

In an embodiment, the first interface is a parallel bus interface, and the second interface is a serial bus interface.

In an embodiment, the first interface is a memory bus, and the second interface is a serial peripheral interface (SPI).

The encoding/decoding module 122 connects with the second interface of the converting module 121. The encoding/decoding module 122 is used for encoding the audio signal and/or the video signal in a VoIP protocol or decoding an encoded audio signal and/or encoded video signal that is encoded in the VoIP protocol. The audio signal and/or the video signal with a second voltage level are transmitted between the converting module 121 and the encoding/decoding module 122 through the second interface. The converting module 121 is operated by the communication processor 11 and converts the voltage level of the audio signal and/or the video signal between the first voltage level and the second voltage level.

In an embodiment, the encoding/decoding module 122 is a digital signal processor.

In an embodiment, the VoIP protocol is H.323, MGCP, or SIP.

The wireless local communication module 123 is electrically connected to the encoding/decoding module 122 and the antenna 124 respectively. The wireless local communication module 123 is used for transmitting the audio signal and/or the video signal out in a wireless local communication protocol via the antenna 124 and receiving the encoded audio signal and/or the encoded video signal received by the antenna 124.

In an embodiment, the wireless communication protocol is IEEE 802.11a, IEEE 802.11b, or IEEE 802.11g.

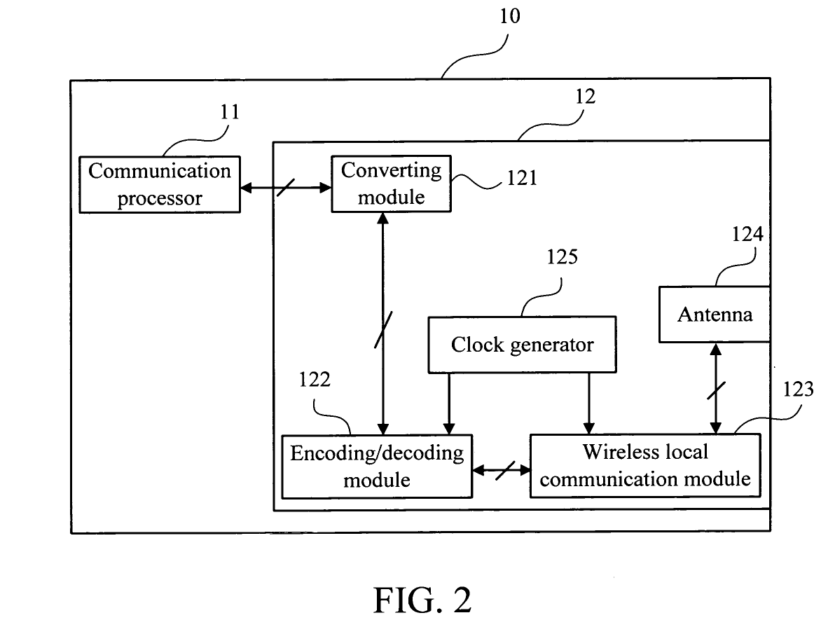

In an embodiment, please referring to FIG. 2, the VoIP apparatus further comprises a clock generator 125. The clock generator 125 is electrically connected to the encoding/decoding module 122 and the wireless local communication module 123 respectively. The clock generator 125 is used for generating a clock. The encoding/decoding module 122 and the wireless local communication module 123 operate based on the clock. Each element in FIG. 2 with the same reference numerals with FIG. 1 has the same operative function with the corresponding element in FIG. 1.

In an embodiment, the encoding/decoding module 122 and the wireless local communication module 123 are configured to receive a clock outputted by the communication processor 11. The encoding/decoding module 122 and the wireless local communication module 123 operate based on the clock.

In practical applications, the mobile communication equipment receives a voice analog signal from a user. The voice analog signal is processed to be a voice digital signal having a first voltage level by the communication processor, and transmitted in the first interface.

The voice digital signal having a first voltage level is converted into a voice digital signal having a second voltage level by a converting module, e.g. a complex programmable logic device, and transmitted in the second interface. The converting module has the function of converting voltage level and interface.

An encoding/decoding module, e.g. a digital signal processor having an encoding/decoding program, receives the voice digital signal having the second voltage level and encodes the signal. The encoded digital signal is transmitted.

A wireless local communication module receives the encoded digital signal, converts it into a packet, and adds an internet table head. The packets are transmitted through an antenna.

On the contrary, when the antenna receives a packet signal, a process flow counter to that mentioned above is performed.

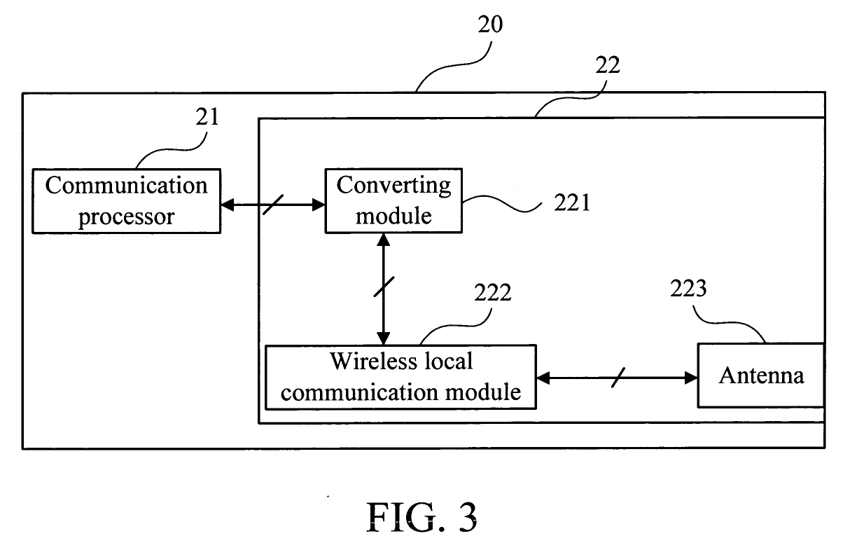

Please refer to FIG. 3. FIG. 3 is a functional block diagram of the VoIP apparatus embedded in a mobile communication equipment in the second preferred embodiment according to the invention.

As shown in FIG. 3, the VoIP apparatus 22 of the second preferred embodiment according to the invention is embedded in a mobile communication equipment 20. The mobile communication equipment 20 comprises a communication processor 21. The communication processor 21 has a stronger function of calculation. The communication processor 21 has a first interface and encodes or decodes an audio signal and/or a video signal in a VoIP protocol.

In an embodiment, the VoIP protocol is H.323, MGCP, or SIP.

The VoIP apparatus 22 comprises a converting module 221, an antenna 223, and a wireless local communication module 222.

The converting module 221 connects with the first interface of the communication processor 21 and has a second interface. An audio signal and/or a video signal with a first voltage level are transmitted between the communication processor 21 and the converting module 221 through the first interface.

In an embodiment, the converting module 121 is a programmable logic device. For example, the programmable logic device can be a field programmable gate array (FPGA) or a complex programmable logic device (CPLD).

In an embodiment, the first interface is a UART interface and the second interface is a general purpose I/O (GPIO) interface.

In an embodiment, the first interface is a USB interface, and the second interface is a UART interface.

In an embodiment, the first interface is a parallel bus interface, and the second interface is a serial bus interface.

In an embodiment, the first interface is a memory bus, and the second interface is a serial peripheral interface (SPI).

The wireless local communication module 222 is electrically connected to the converting module 221 and the antenna 223 respectively. The wireless local communication module 222 is used for transmitting the audio signal and/or the video signal out in a wireless local communication protocol via the antenna 223 and receiving the encoded audio signal and/or the encoded video signal received by the antenna 223. The audio signal and/or the video signal with a second voltage level are transmitted between the converting module 221 and the wireless local communication module 222 through the second interface. The converting module 221 is operated by the communication processor 21 and converts the voltage level of the audio signal and/or the video signal between the first voltage level and the second voltage level.

In an embodiment, the wireless communication protocol is IEEE 802.11a, IEEE 802.11b, or IEEE 802.11g.

In an embodiment, the wireless local communication module 222 is configured to receive a clock outputted by the communication processor 21. The wireless local communication module 222 operates based on the clock.

Compared to the prior arts, in a VoIP apparatus of the first or second preferred embodiment according to the invention, a converting module, e.g. a complex programmable logic device, is used for converting the voltage level and interface between the communication module and the VoIP apparatus. Therefore, it is not needed to spend plenty of time looking for the VoIP apparatus which matches the different communication modules. The converting module is capable of converting the voltage level and interface of the different communication modules. Therefore, the dual mode mobile product can reach the goal of entering the market immediately.

With the above example and explanation, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A VoIP apparatus embedded in a mobile communication equipment comprising a communication processor having a first interface, said VoIP apparatus comprising:
a converting module, connecting with the first interface of the communication processor, having a second interface, an audio signal and/or a video signal with a first voltage level being transmitted between the communication processor and the converting module through the first interface;
an encoding/decoding module, connecting with the second interface of the converting module, for encoding the audio signal and/or the video signal in a VoIP protocol or decoding an encoded audio signal and/or an encoded video signal, the audio signal and/or the video signal with a second voltage level being transmitted between the converting module and the encoding/decoding module through the second interface, wherein the converting module, operated by the communication processor, converts the voltage level of the audio signal and/or the video signal between the first voltage level and the second voltage level;
an antenna; and
a wireless local communication module, electrically connected to the encoding/decoding module and the antenna respectively, for transmitting the audio signal and/or the video signal out in a wireless local communication protocol via the antenna, and receiving the encoded audio signal and/or the encoded video signal received by the antenna.

2. The VoIP apparatus of claim 1, wherein the converting module is a programmable logic device.

3. The VoIP apparatus of claim 1, wherein the encoding/decoding module is a digital signal processor.

4. The VoIP apparatus of claim 1, wherein the VoIP protocol is H.323, MGCP, or SIP.

5. The VoIP apparatus of claim 1, wherein the wireless local communication protocol is IEEE 802.11a, IEEE 802.11b, or IEEE 802.11g.

6. The VoIP apparatus of claim 1, further comprising a clock generator, electrically connected to the encoding/decoding module and the wireless local communication module respectively, for generating a clock, wherein the encoding/decoding module and the wireless local communication module operate based on the clock.

7. The VoIP apparatus of claim 1, wherein the encoding/decoding module and the wireless local communication module are configured to receive a clock outputted by the communication processor, and wherein the encoding/decoding module and the wireless local communication module operate based on the clock.

8. The VoIP apparatus of claim 1, wherein the first interface is a UART interface, and the second interface is a GPIO interface.

9. The VoIP apparatus of claim 1, wherein the first interface is a USB interface, and the second interface is a UART interface.

10. The VoIP apparatus of claim 1, wherein the first interface is a parallel bus, and the second interface is a serial bus.

11. The VoIP apparatus of claim 1, wherein the first interface is a memory bus, and the second interface is an SPI interface.

12. A VoIP apparatus embedded in a mobile communication equipment comprising a communication processor which has a first interface and encodes an audio signal and/or a video signal in a VoIP protocol or decodes an encoded audio signal and/or an encoded video signal, said VoIP apparatus comprising:
a converting module, connecting with the first interface of the communication processor, having a second interface, the encoded audio signal and/or the encoded video signal with a first voltage level being transmitted between the communication processor and the converting module through the first interface;
an antenna; and
a wireless local communication module, electrically connected to the converting module and the antenna respectively, for transmitting the audio signal and/or the video signal out in wireless local communication protocol via the antenna, and receiving the encoded audio signal and/or the encoded video signal received by the antenna, wherein the encoded audio signal and/or the encoded video signal with a second voltage level being transmitted between the converting module and the wireless local communication module through the second interface, wherein the converting module, operated by the communication processor, converts the voltage level of the encoded audio signal and/or the encoded video signal between the first voltage level and the second voltage level.

13. The VoIP apparatus of claim 12, wherein the converting module is a programmable logic device.

14. The VoIP apparatus of claim 12, wherein the VoIP protocol is H.323, MGCP, or SIP.

15. The VoIP apparatus of claim 12, wherein the wireless communication protocol is IEEE 802.11a, IEEE 802.11b, or IEEE 802.11g.

16. The VoIP apparatus of claim 12, wherein the wireless local communication module is also configured to receive a clock outputted by the communication processor, wherein the wireless local communication module operates based on the clock.

17. The VoIP apparatus of claim 12, wherein the first interface is a UART interface, and the second interface is a GPIO interface.

18. The VoIP apparatus of claim 12, wherein the first interface is a USB interface, and the second interface is a UART interface.

19. The VoIP apparatus of claim 12, wherein the first interface is a parallel bus, and the second interface is a serial bus.

20. The VoIP apparatus of claim 12, wherein the first interface is a memory bus, and the second interface is an SPI interface.
